(19) United States
(12) Patent Application Publication
(10) Pub. No.: US 2026/0147103 A1
(43) Pub. Date: May 28, 2026

(54) RADAR DETECTION AND CLASSIFICATION USING AN AUTO REGRESSIVE SPECTRAL ESTIMATOR WITH MACHINE LEARNING

(71) Applicant: Elta Systems Ltd., Ashdod (IL)

(72) Inventor: Arie AMARA, Ako (IL)

(21) Appl. No.: 19/371,137

(22) Filed: Oct. 28, 2025

(30) Foreign Application Priority Data
Oct. 31, 2024 (IL) 316731

(51) Int. Cl. G01S 13/04; G01S 7/288; G01S 13/89

(52) U.S. Cl. CPC G01S 13/04; G01S 7/2886; G01S 13/89

(57) ABSTRACT

A processing circuitry-based method of detecting radar targets, comprising: receiving a series of radar pulse measurements; generating an autoregressive (AR) spectral estimation, of a given order, from the received data, thereby resulting in two or more complex coefficients of an estimated AR model; utilizing the two or more complex coefficients as input to one or more trained machine learning models, thereby resulting in, at least: an indication of presence or absence of a target, and responsive to presence of the target: a distance, an energy, and a velocity of the target, the one or more models having been trained to receive data derivative of complex coefficients and output data informative of target depth, energy, and velocity.

### TECHNICAL FIELD

The presently disclosed subject matter relates to radar detection, and in particular to machine learning/artificial intelligence-based enhancements to detection and identification of radar targets.

### BACKGROUND

Problems of detection in radar systems have been recognized in the conventional art and various techniques have been developed to provide solutions.

### GENERAL DESCRIPTION

According to one aspect of the presently disclosed subject matter there is provided a method of detecting radar targets, the method comprising:
a) receiving data derivative of a series of radar pulse measurements;
b) generating an autoregressive (AR) spectral estimation, of a given order, from the received data, thereby resulting in two or more complex coefficients of an estimated AR model;
c) utilizing data derivative of the two or more complex coefficients as input to one or more trained machine learning models, thereby resulting in, at least:
   a. an indication of presence or absence of a target, and
   b. responsive to presence of the target:
      a distance, an energy, and a velocity of the target,
   the one or more models having been trained to receive data derivative of complex coefficients and output data informative of target depth, energy, and velocity.

In addition to the above features, the system according to this aspect of the presently disclosed subject matter can comprise one or more of features (i) to (x) listed below, in any desired combination or permutation which is technically possible:
(i) the utilizing the data as input to the trained machine learning models further results in, responsive to presence of the target:
   data indicative of a target identification.
(ii) the data derivative of the series of radar pulse measurements comprises in-phase and quadrature (I/Q) data.
(iii) the given order is four.
(iv) the data derivative of the complex coefficients is data informative of pole coordinates.
(v) the pole coordinates are based on roots of:

$$1 - {\sum }_{k = 1}^{p} {a}^{k} {z}^{k}$$

where p is the given order of the estimated model, a^{k} are the complex coefficients of the estimated model, and z^{k} are the radar pulse measurements.
(vi) the data derivative of the complex coefficients is polar map image data based on pole coordinates, the pole coordinates being based on the complex coefficients of the estimated model.
(vii) the performing complex autoregressive spectral estimation comprises at least one of:
   a) least squares estimation,
   b) Yule-Walker equation computation,
   c) Levinson-Durbin algorithm,
   d) Burg's method,
   e) maximum likelihood estimation,
   f) parametric estimation with Kalman filtering, and
   g) predictive error minimization.
(viii) the method additionally comprising, prior to step b):
   evaluating presence of a target, based on applying signal processing techniques to an AR spectral estimation of order two of data derivative of the series of radar pulses; and wherein the generating is responsive to successful evaluating of the presence of the target.
(ix) the method additionally comprising, subsequent to c):
   verifying the distance, energy, and velocity of the target, based on at least one of:
      i. utilizing a constant false alarm rate (CFAR) method in conjunction with a range-Doppler map based on data derivative of the series of radar pulses; and
      ii. applying signal processing techniques to an AR spectral estimation of order two of data derivative of the series of radar pulses.
(x) at least one of the one or more machine learning models was trained by a method comprising:
   a. receiving data that is derivative of AR spectral estimation coefficients associated with a given radar target;
   b. receiving ground truth data associated with the given radar target, the ground truth data comprising at least one of:
      i. a distance,
      ii. an energy,
      iii. a velocity, and
      iv. an identification
         associated with the given radar target;
   c. training the machine learning model based on the received data derivative of the AR spectral estimation coefficients and the received ground truth data.

According to another aspect of the presently disclosed subject matter there is provided a system of detecting radar targets, the system comprising a processing circuitry configured to:
a) receive data derivative of a series of radar pulse measurements;
b) generate an autoregressive (AR) spectral estimation, of a given order, from the received data, thereby resulting in two or more complex coefficients of an estimated AR model;
c) utilize data derivative of the two or more complex coefficients as input to one or more trained machine learning models, thereby resulting in, at least:
   a. an indication of presence or absence of a target, and
   b. responsive to presence of the target:
      a distance, an energy, and a velocity of the target,
   the one or more models having been trained to receive data derivative of complex coefficients and output data informative of target depth, energy, and velocity.

This aspect of the disclosed subject matter can further optionally comprise one or more of features (i) to (x) listed above with respect to the method, mutatis mutandis, in any desired combination or permutation which is technically possible.

According to another aspect of the presently disclosed subject matter there is provided a computer program product comprising a computer readable non-transitory storage medium containing program instructions, which program instructions when read by a processor, cause the processing circuitry to perform a method of detecting radar targets, the method comprising:
a) receiving data derivative of a series of radar pulse measurements;
b) generating an autoregressive (AR) spectral estimation, of a given order, from the received data, thereby resulting in two or more complex coefficients of an estimated AR model;
c) utilizing data derivative of the two or more complex coefficients as input to one or more trained machine learning models, thereby resulting in, at least:
   a. an indication of presence or absence of a target, and
   b. responsive to presence of the target:
      a distance, an energy, and a velocity of the target,
   the one or more models having been trained to receive data derivative of complex coefficients and output data informative of target depth, energy, and velocity.

This aspect of the disclosed subject matter can further optionally comprise one or more of features (i) to (x) listed above with respect to the method, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 is a logical block diagram of an example radar unit and system of target detection utilizing spectral autoregression, in accordance with some embodiments of the presently disclosed subject matter;

FIGS. 2A-2B illustrate example polar maps of autoregressive estimations of radar data, in accordance with some embodiments of the presently disclosed subject matter;

FIG. 3 is a flow diagram of an example method of determining radar target characteristics based on machine learning in conjunction with autoregressive spectral estimation, in accordance with some embodiments of the presently disclosed subject matter; and

FIG. 4 is a flow diagram of an example method of training a machine learning model to classify autoregressive spectral estimation data to radar target characteristics based on, in accordance with some embodiments of the presently disclosed subject matter; and

FIG. 5 is a flow diagram of an example method of determining radar target characteristics based on multiple methods, including autoregressive spectral estimation, in accordance with some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “encrypting”, “decrypting”, “determining”, “calculating”, “receiving”, “providing”, “obtaining”, “emulating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein. Some prior art systems seek to enhance radar target detection using machine learning. Some such systems have attempted to utilize range-doppler (RD) maps. An RD map typically has an x axis based on target distance and a y axis based on doppler shift (e.g. in meters/s). Dots in the RD map can have a color indicative of signal strength.

Some embodiments of the presently disclosed subject matter utilize a different approach to machine learning enhancement of radar detection, and utilize autoregressive spectral estimation in conjunction with polar maps (i.e. a form of dimensional reduction), as will be described in detail below.

Utilizing autoregressive spectral estimation and the techniques disclosed here in can result in improved detection and target identification. Advantages of these methods can include the following:
Absence of Fourier transfer requirement enables higher frequency resolution and separation
Elimination of requirement to perform Moving Target Indicator using High-Pass Filtering (MTI-HPF) for weak targets
Utilization of large dynamic range, so as detect strong and weak targets simultaneously
Improved detection for low snr and slow velocity targets in the clutter
Effectiveness with shorter pulse series (due to small order of autoregressive regression)
Avoidance of false detections from sidelobes
Better identification in situations of high signal-to-clutter
Better reproducibility (on site training) due to universal calibration for normalized polar representation

This technique can be especially effective for detection of small/(low SNR) and slow targets (i.e drones and unmanned aerial vehicles (UAVS) and for classification of jets/propellers and birds to prevent false alarms.

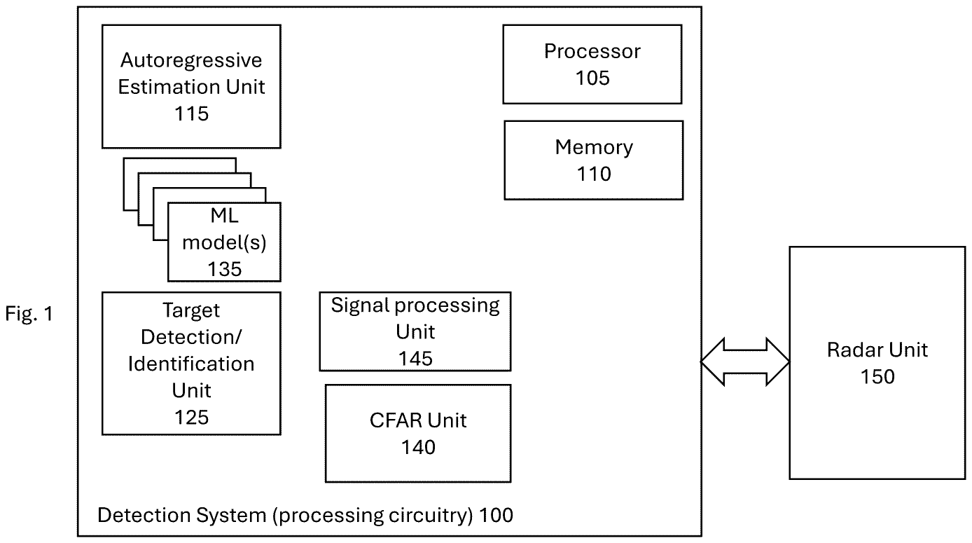

FIG. 1 is a logical block diagram of an example radar unit and system of target detection utilizing spectral autoregression, in accordance with some embodiments of the presently disclosed subject matter.

Radar unit 150 can be a suitable type of radar equipment. Radar unit 150 can transmit radar pulses toward targets (e.g. within a particular range window) and can generate data (e.g. in-phase and quadrature (I/Q) data) based on detected return radar pulses.

Radar unit 150 can be operably connected to detection system (processing circuitry) 100—for example, via a suitable network connection. Alternatively, radar unit 150 can be physically collocated with detection system (processing circuitry) 100.

Detection system (processing circuitry) 100 can include processor 105 and memory 110.

Processor 105 can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 105 can also consist, for example, of multiple processors, multiple ASICs, virtual processors, combinations thereof etc.

Memory 110 can be, for example, a suitable kind of volatile and/or non-volatile storage, and can include, for example, a single physical memory component or a plurality of physical memory components. Memory 110 can also include virtual memory. Memory 110 can be configured to, for example, store various data used in computation.

Detection system (processing circuitry) 100 can be configured to execute several functional modules in accordance with computer-readable instructions implemented on a non-transitory computer-readable storage medium. Such functional modules are referred to hereinafter as comprised in the processing circuitry. These modules can include, for example: autoregressive estimation unit 115, target detection/identification unit 125, machine learning model(s) 135, constant false alarm rate (CFAR) Unit 140, and signal processing unit 145.

Target detection/identification unit 125 can be a hardware or software module which processes radar data (e.g. I/Q data) and determines whether a target is present. Target detection/identification unit 125 can further determine the distance, velocity, and energy of one or more detected targets. In some embodiments, target detection/identification unit 125 can further determine the type of target eg. airplane, helicopter, missile, birds etc., or even a particular type of airplane etc.

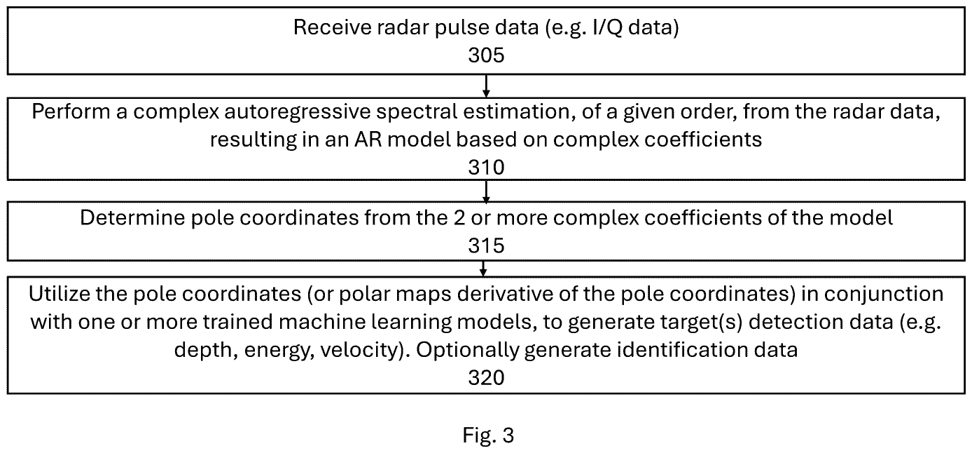

Target detection/identification unit 125 can perform detection/identification using a method such as the one described in FIG. 3 below.

Autoregressive estimation unit 115 can receive radar data (e.g. I/Q data), and estimate an autoregressive (AR) model based on the data.

By way of non-limiting example, autoregressive estimation unit 115 can estimate an AR model of a given order (e.g. AR(4)) by determining complex-domain AR coefficients aₖ such that:

$$x ( t ) = - ( t ) = {\sum }_{k = 1}^{p} {a}_{k} x ( t - k ) + e ( t )$$

where:
x(t) is the signal at time t
p is the order of the estimation (e.g. 4) and
e(t) is white noise.

In some embodiments, autoregressive estimation unit 115 can further calculate poles of the estimated AR model. For example: autoregressive estimation unit 115 can calculate the poles by determining solutions of the characteristic equation:

$$1 - {\sum }_{k = 1}^{p} {a}^{k} {z}^{k} = 0$$

ML model(s) 135 can one or more machine learning models that have been trained to determine characteristics of targets from AR modeling data.

For example: ML model(s) 135 can be a classification model which receives vector data indicative of poles of an AR(4) estimation, and generates an indication of whether or how many targets are present. In some examples, ML model(s) 135 can generate indications of a single target with multiple velocities (e.g. due to fans and propellers). ML model(s) 135 can generate distance (e.g. in kilometres (km)), velocity (e.g. in meters/second), and energy (e.g. in decibels relative to a milliwatt (dBm)) for one or more targets and/or target components.

ML models(s) 135 can be e.g. pretrained before deployment of the detection system (processing circuitry).

Signal processing unit 145 can perform conventional (e.g. non-machine-learning based) target detection methods. CFAR unit 140 can perform constant false alarm rate detection.

It is noted that the teachings of the presently disclosed subject matter are not bound by the system described with reference to FIG. 1 and other figures herein. Equivalent and/or modified functionality can be consolidated or divided in another manner and can be implemented in any appropriate combination of software with firmware and/or hardware and executed on a suitable device. Detection system (processing circuitry) 100 can be a standalone entity, or integrated, fully or partly, with other entities.

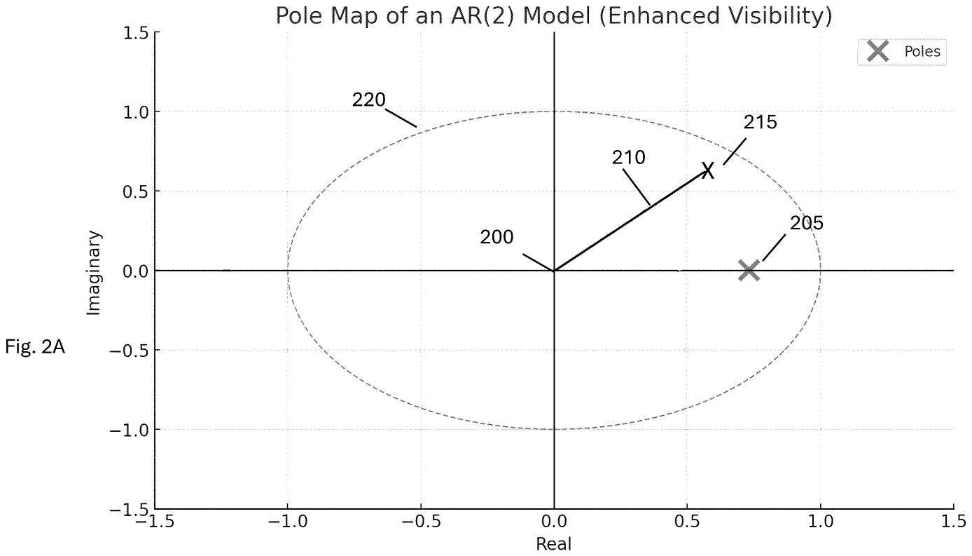

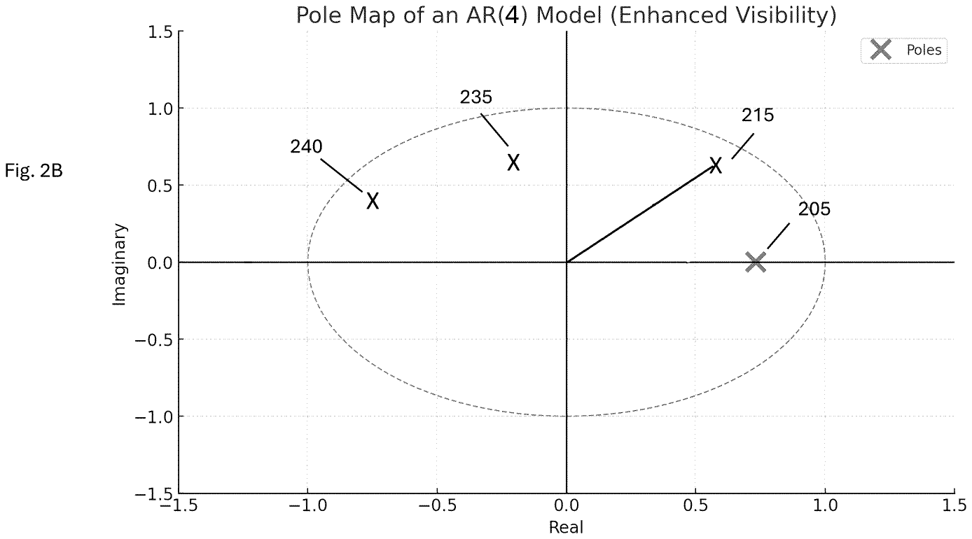

FIGS. 2A-2B illustrate example polar maps of autoregressive estimations of radar data, in accordance with some embodiments of the presently disclosed subject matter.

FIG. 2A is an example polar map based on an AR(2) model.

The real and imaginary axes are marked, as is unit circle 220. Each of the two poles 205 215 shown in FIG. 2A represents a radar target.

The first pole 205 represents a stationary element. The angle 210 from the origin 200 to the second pole 215 represents the velocity of a particular target. The distance from the origin represents the target energy.

FIG. 2B is an example polar map based on an AR(4) model.

In this example, the three non-stationary poles 215 235 240 can represent three different speeds (e.g. one target and 2 propellers or jets). It is noted that if—for a particular range gate—multiple velocities are detected, it can be likely that this is due to presence of a single target with components of multiple velocities. It is accordingly noted that utilizing polar-map based machine learning detection can have better ability to identify jets, propellers etc. as well as birds etc., and thus can avoid false target detections.

A pole with low energy can indicate noise.

FIG. 3 is a flow diagram of an example method of determining radar target characteristics based on machine learning in conjunction with autoregressive spectral estimation, in accordance with some embodiments of the presently disclosed subject matter.

Detection system (processing circuitry) 100 (e.g. autoregressive estimation unit 115) can receive 305 radar pulse return data (e.g. I/Q data) from e.g. radar unit 150.

Detection system (processing circuitry) 100 (e.g. autoregressive estimation unit 115) can generate 310 an autoregressive spectral estimation, of a given order (e.g. 4), from the radar data.

By way of non-limiting example, detection system (processing circuitry) 100 (e.g. autoregressive estimation unit 115) can estimate an AR model of a given order (e.g. AR(4)) by determining complex-domain AR coefficients aₖ such that:

$$x ( t ) = - ( t ) = {\sum }_{k = 1}^{p} {a}_{k} x ( t - k ) + e ( t )$$

where:
x(t) is the signal at time t
p is the order of the estimation (e.g. 4) and
e(t) is white noise.

Detection system (processing circuitry) 100 (e.g. autoregressive estimation unit 115) can estimate the AR model in various ways e.g. least squares estimation, Yule-Walker equation computation, Levinson-Durbin algorithm, Burg's method, maximum likelihood estimation, parametric estimation with Kalman filtering, predictive error minimization, or other suitable methods.

Detection system (processing circuitry) 100 (e.g. autoregressive estimation unit 115) can next determine 315 pole coordinates from the two or more complex coefficients of the AR model.

For example: detection system (processing circuitry) 100 (e.g. autoregressive estimation unit 115) can calculate the poles by determining solutions of the characteristic equation:

$$1 - {\sum }_{k = 1}^{p} {a}^{k} {z}^{k} = 0$$

Detection system (processing circuitry) 100 (e.g. autoregressive estimation unit 115) can then utilize the determined pole coordinates in conjunction with one or more trained machine learning models, to generate target(s) detection data (e.g. depth, energy, velocity).

ML model(s) 135 can one or more machine learning models that have been trained to determine characteristics of targets from AR modeling data.

For example: ML model(s) 135 can be a classification model which receives vector data indicative of poles of an AR(4) estimation, and generates an indication of whether or how many targets are present, as well as distance (e.g. in kilometers (km)), velocity (e.g. in meters/second), and energy (e.g. in decibels relative to a milliwatt (dBm)) for one or more targets.

In some embodiments, detection system (processing circuitry) 100 (e.g. autoregressive estimation unit 115) provides the poles data to the ML model(s) 135 as vectors e.g. each pole can be represented as a pair [x, y] where x is the real component and y is the complex component. In some embodiments, detection system (processing circuitry) 100 (e.g. autoregressive estimation unit 115) provides the poles data to the ML model(s) 135 as graphical representations (e.g. similar to those depicted in FIGS. 2A-2B.) In some embodiments, detection system (processing circuitry) 100 (e.g. autoregressive estimation unit 115) provides the poles data to the ML model(s) 135 in another suitable representation.

It is noted that in some embodiments, detection system (processing circuitry) 100 (e.g. autoregressive estimation unit 115) can provide other data that is derivative of the AR estimation to the ML model(s) 135, and not specifically the poles. In this case, suitably trained models of ML model(s) 135 utilize (e.g. classify) the data derivative of the AR estimation (e.g. the calculated complex coefficients or data derivative the calculated complex coefficients), to generate an indication of whether or how many targets are present, as well as distance (e.g. in kilometers (km)), velocity (e.g. in meters/second), and energy (e.g. in decibels relative to a milliwatt (dBm)) for one or more targets.

Detection system (processing circuitry) 100 (e.g. autoregressive estimation unit 115) can optionally utilize the pole coordinates (or polar maps derivative of the pole coordinates) in conjunction with one or more trained machine learning models, to generate target identification data (e.g. jet, helicopter, bird). By way of non-limiting example: one or more distinct machine learning models of ML model(s) 135 can be trained to determine identification of targets from the AR modeling data.

It is noted that the teachings of the presently disclosed subject matter are not bound by the flow diagrams illustrated in FIGS. 3-5, and that in some cases the illustrated operations may occur concurrently or out of the illustrated order. It is also noted that whilst the flow chart is described with reference to elements of the system of FIG. 1, this is by no means binding, and the operations can be performed by elements other than those described herein.

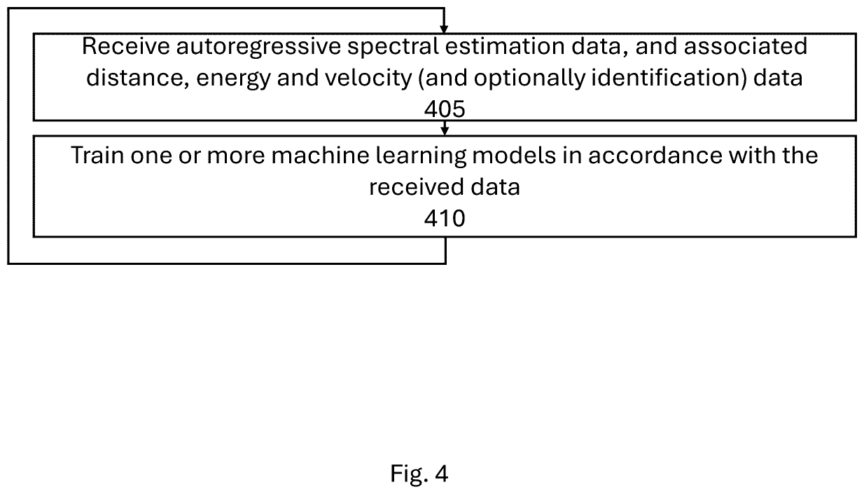

FIG. 4 is a flow diagram of an example method of training a machine learning model to classify autoregressive spectral estimation data to radar target characteristics based on, in accordance with some embodiments of the presently disclosed subject matter.

The method illustrated in FIG. 4 can be performed, for example, by a training system (not depicted) comprising a processor and memory. The trained machine learning models can be—for example—installed on detection system (processing circuitry) 100.

The training system can receive 405 autoregressive spectral estimation data derived from radar data (for example: vector data indicating poles of on AR(4) estimation), and associated ground truth data such as: whether a target is present, and distance, energy and velocity of the target. Optionally: target identification data (e.g. airplane, projectile, helicopter etc.) can be included in the ground truth data.

The training system can train 410 one or more machine learning models in accordance with the received data and received ground truth.

The training system can repeat the sequence for additional training data.

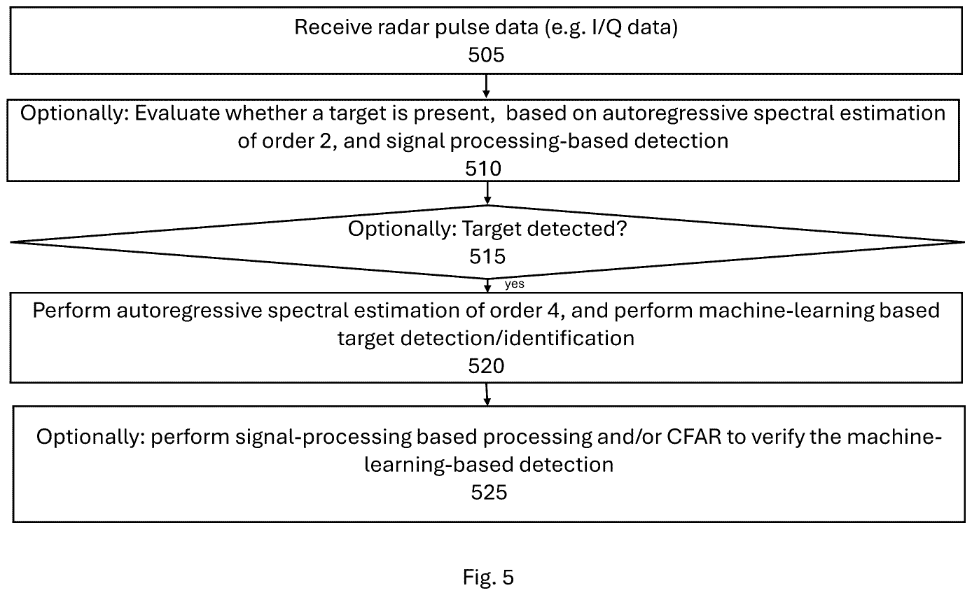

FIG. 5 is a flow diagram of an example method of determining radar target characteristics based on multiple methods, including autoregressive spectral estimation, in accordance with some embodiments of the presently disclosed subject matter.

In some examples, detection system (processing circuitry) 100 can initially perform target detection using a non-machine learning-based method. For example, detection system (processing circuitry) 100 can create a range-doppler (RD) map, and perform CFAR detection in conjunction with the RD map, as known in the art. In some such examples, if the detection fails or the result is ambiguous, detection system (processing circuitry) 100 can then proceed to utilize a method based on FIG. 3 or FIG. 5.

Detection system (processing circuitry) 100 (e.g. autoregressive estimation unit 115) can receive 505 radar pulse return data (e.g. I/Q data) from e.g. radar unit 150.

Detection system (processing circuitry) 100 (e.g. autoregressive estimation unit 115) can optionally evaluate 510 presence of a target, based on utilizing signal processing techniques in conjunction with an AR spectral estimation of order 2 (i.e. where the estimation is based on data derivative of the series of radar pulses).

If the evaluation is successful i.e. a target was detected 515, detection system (processing circuitry) 100 (e.g. autoregressive estimation unit 115) can perform 520 machine-learning-based detection of a target and its depth, velocity, and energy (and optionally determine identification data), as described above with reference to FIG. 3.

Detection system (processing circuitry) 100 (e.g. autoregressive estimation unit 115) can next (optionally) verify the results of the machine-learning-based detection/identification by utilizing, for example, one or more of:
Signal processing techniques in conjunction with an AR spectral estimation of order 2 (i.e. where the estimation is based on data derivative of the series of radar pulses). For example: if machine-learning detection indicates a target with velocity of 2 kilometers/second together with a jet of velocity 5 kilometers/second, detection system (processing circuitry) 100 (e.g. autoregressive estimation unit 115) can confirm that the AR(2) spectral estimation shows a velocity of 5 kilometers/second+/−a certain potential variation.
Applying CFAR to a range-doppler map that is based on data derivative of the series of radar pulses.

The verification can ensure that range, energy, and/or velocity as indicated by the machine-learning based identification are consistent with the other detection methods. The verification can also ensure that the target identification data (i.e. airplane, helicopter etc.) as indicated by the machine-learning based identification is consistent with the other detection methods.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A processing circuitry-based method of detecting radar targets, the processing circuitry-based method comprising:
a) receiving data derivative of a series of radar pulse measurements;
b) generating an autoregressive (AR) spectral estimation, of a given order, from the received data, thereby resulting in two or more complex coefficients of an estimated AR model;
c) utilizing data derivative of the two or more complex coefficients as input to one or more trained machine learning models, thereby resulting in, at least:
a. an indication of presence or absence of a target, and
b. responsive to presence of the target:
a distance, an energy, and a velocity of the target,
the one or more models having been trained to receive data derivative of complex coefficients and output data informative of target depth, energy, and velocity.

2. The processing circuitry-based method of claim 1, wherein the utilizing the data as input to the trained machine learning models further results in, responsive to presence of the target:
data indicative of a target identification.

3. The processing circuitry-based method of claim 1, wherein the data derivative of the series of radar pulse measurements comprises in-phase and quadrature (I/Q) data.

4. The processing circuitry-based method of claim 1, wherein the given order is four.

5. The processing circuitry-based method of claim 1, wherein the data derivative of the complex coefficients is data informative of pole coordinates.

6. The processing circuitry-based method of claim 5, wherein the pole coordinates are based on roots of
$$1 - {\sum }_{k = 1}^{p} {a}^{k} {z}^{k}$$
where p is the given order of the estimated model, a^{k} are the complex coefficients of the estimated model, and z^{k} are the radar pulse measurements.

7. The processing circuitry-based method of claim 5, wherein the data derivative of the complex coefficients is polar map image data based on pole coordinates, the pole coordinates being based on the complex coefficients of the estimated model.

8. The processing circuitry-based method of claim 1, wherein the performing complex autoregressive spectral estimation comprises at least one of:
a) least squares estimation,
b) Yule-Walker equation computation,
c) Levinson-Durbin algorithm,
d) Burg's method,
e) maximum likelihood estimation,
f) parametric estimation with Kalman filtering, or
g) predictive error minimization.

9. The processing circuitry-based method of claim 4, the method additionally comprising, prior to step b):
evaluating presence of a target, based on applying signal processing techniques to an AR spectral estimation of order two of data derivative of the series of radar pulses;
and wherein the generating is responsive to successful evaluating of the presence of the target.

10. The processing circuitry-based method of claim 9, the method additionally comprising, subsequent to c):
verifying the distance, energy, and velocity of the target, based on at least one of:
i. utilizing a constant false alarm rate (CFAR) method in conjunction with a range-Doppler map based on data derivative of the series of radar pulses; and
ii. applying signal processing techniques to an AR spectral estimation of order two of data derivative of the series of radar pulses.

11. The processing circuitry-based method of claim 1, wherein at least one of the one or more machine learning models was trained by a method comprising:
a. receiving data that is derivative of AR spectral estimation coefficients associated with a given radar target;
b. receiving ground truth data associated with the given radar target, the ground truth data comprising at least one of:
i. a distance,
ii. an energy,
iii. a velocity, and
iv. an identification
associated with the given radar target;
c. training the machine learning model based on the received data derivative of the AR spectral estimation coefficients and the received ground truth data.

12. A system of detecting radar targets, the system comprising:
a processing circuitry configured to:
a) receive data derivative of a series of radar pulse measurements;
b) generate an autoregressive (AR) spectral estimation, of a given order, from the received data, thereby resulting in two or more complex coefficients of an estimated AR model;
c) utilize data derivative of the two or more complex coefficients as input to one or more trained machine learning models, thereby resulting in, at least:
a. an indication of presence or absence of a target, and
b. responsive to presence of the target:
a distance, an energy, and a velocity of the target,
the one or more models having been trained to receive data derivative of complex coefficients and output data informative of target depth, energy, and velocity.

13. A computer program product comprising a computer readable non-transitory storage medium containing program instructions, which program instructions when read by a processor, cause the processing circuitry to perform a method of detecting radar targets, the method comprising:
a) receiving data derivative of a series of radar pulse measurements;
b) generating an autoregressive (AR) spectral estimation, of a given order, from the received data, thereby resulting in two or more complex coefficients of an estimated AR model;
c) utilizing data derivative of the two or more complex coefficients as input to one or more trained machine learning models, thereby resulting in, at least:
a. an indication of presence or absence of a target, and
b. responsive to presence of the target:
a distance, an energy, and a velocity of the target,
the one or more models having been trained to receive data derivative of complex coefficients and output data informative of target depth, energy, and velocity.
